(19) United States
(12) Patent Application Publication
(10) Pub. No.: US 2014/0357369 A1
(43) Pub. Date: Dec. 4, 2014

(54) GROUP INPUTS VIA IMAGE SENSOR SYSTEM

(71) Applicant: Microsoft Corporation, Redmond, WA (US)

(72) Inventors: Adam Callens, Redmond, WA (US); Michael Scott Seamons, Redmond, WA (US); Roger Kurtz, Seattle, WA (US); Marie Elizabeth Whallon, Seattle, WA (US); Kim McAuliffe, Seattle, WA (US); Louise Mary Smith, Seattle, WA (US); Henry C. Sterchi, Redmond, WA (US); Soren Hannibal Nielsen, Kirkland, WA (US); Michael Saxs Persson, Redmond, WA (US); David McCarthy, Mercer Island, WA (US); Bruce Heather, East Sussex (GB); David Amor, East Sussex (GB); Tim Aidley, East Sussex (GB); Scott Rowlands, East Sussex (GB)

(21) Appl. No.: 13/910,049

(22) Filed: Jun. 4, 2013

(51) Int. Cl. A63F 13/213; A63F 13/428; A63F 13/426

(52) U.S. Cl. CPC A63F 13/213; A63F 13/426; A63F 13/428
USPC 463/36

(57) ABSTRACT

Embodiments that relate to detecting via an image sensor inputs made by a group of users are provided. For example, one disclosed embodiment provides a method including receiving image information of the play space from a capture device, identifying a body of a user within the play space from the received image information, and identifying a head within the play space from the received image information. The method further includes associating the head with the body of the user, identifying an extremity, and if the extremity meets a predetermined condition relative to one or more of the head and body, then performing an action via the computing device.

### BACKGROUND

Interactive video experiences, such as video games and interactive television, may allow users to interact with the experiences via various input devices. For example, users may control characters, reply to quizzes, etc. Conventional interactive video entertainment systems, such as conventional video game consoles, may utilize one or more special hand-held controllers to allow users to make inputs to control such experiences. However, such controllers may be awkward and slow to use when a number of participants exceeds a number of controllers supported by the system.

### SUMMARY

Embodiments for detecting inputs made by a group of users via an image sensor system are disclosed. One example method comprises receiving image information of the play space from a capture device, identifying a body of a user within the play space from the received image information, and identifying a head within the play space from the received image information. The method may further comprise associating the head with the body of the user, identifying an extremity, and if the extremity meets a predetermined condition relative to one or more of the head and body, then performing an action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a non-limiting embodiment of a use environment for group participation in an interactive video experience.

FIG. 2 shows an embodiment of processed image data for the use environment presented in FIG. 1.

FIG. 3 is a flow chart illustrating a method for entering a vote according to an embodiment of the present disclosure.

FIG. 4 schematically shows a non-limiting embodiment of a computing system.

### DETAILED DESCRIPTION

As mentioned above, some input devices for a computing system, such as keyboards, remote controls, hand-held game controllers, may be difficult to adapt to an environment in which a number of users exceeds a number of available or supported input devices.

In contrast, input devices comprising image sensors, such as depth sensors and two-dimensional image sensors, may allow a group of users to be simultaneously imaged, and thus may allow multiple users to simultaneously make input gestures. However, detecting and tracking a large number of users may be computationally intensive. Briefly, depth image data may be used to identify users in the form of a collection of joints and vertices between the joints, i.e. as virtual skeletons. However, tracking a large number of skeletons may utilize more processing power than is available on a computing device receiving inputs from the depth sensor.

Thus, embodiments are disclosed herein that utilize image data, such as depth image data and two-dimensional image data, to detect actions performed by multiple users in a group of users using lower resolution tracking methods than skeletal tracking. For example, each user imaged within a scene may be tracked using a low-resolution tracking method such as blob identification, wherein a blob corresponds to a mass in a scene identified from depth images. Further, head-tracking methods may be used to track heads in a scene as well. With this information, blobs identified in an imaged scene may be associated with heads to identify head-body pairs that represent users. Then, if a mass is identified near the head of a head-body pair, the mass may be identified as a raised hand of the user.

By identifying if a user has raised his or her hand, the detected raised hand may be used as an input to a program running on a computing device, and the computing device may perform an action in response. One non-limiting example of an action that may be performed in response to a raised hand includes registering that a user has entered a vote for a selection presented in an interactive entertainment item via the computing device. In this way, input from multiple users may be tracked using low-resolution tracking methods. By using low-resolution tracking methods, a relatively larger number of users may be tracked at one time compared to the use of skeletal tracking. This may allow a relatively larger number of users to interact with the computing device via natural user inputs.

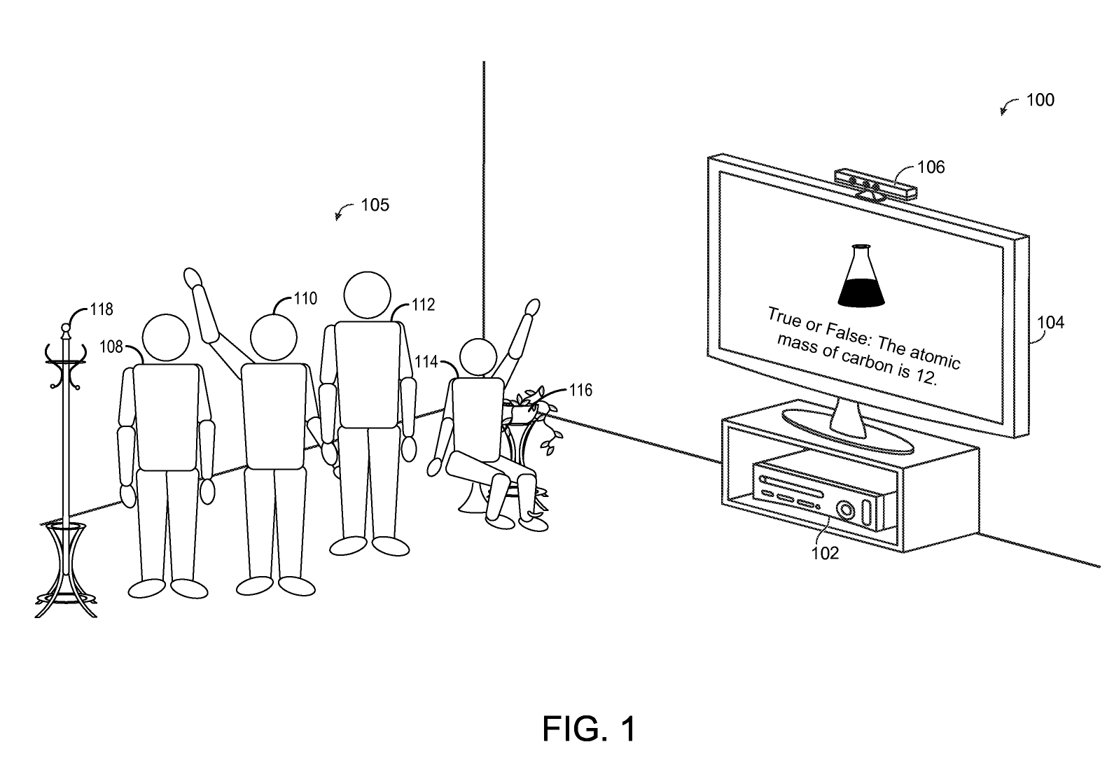

FIG. 1 shows a non-limiting example of an interactive entertainment use environment 100 that may allow multiple users to enter natural user input data. In particular, FIG. 1 shows an entertainment system 102 that may be used to play a variety of different games, play one or more different media types, and/or control or manipulate non-game applications and/or operating systems. FIG. 1 also shows a display device 104 such as a television or a computer monitor, which may be used to present media content, game visuals, etc., to users. As one example, display device 104 may be used to visually present video content that includes one or more selectable choices, such as video content that includes a question having multiple selectable answers. Interactive entertainment use environment 100 may include a capture device 106, such as a depth camera that visually monitors or tracks objects and users within play space 105. In the example interactive entertainment use environment 100 depicted in FIG. 1, a plurality of users are interacting with entertainment system 102 and/or display device 104. For example, users 108, 110, 112, and 114 are shown in play space 105.

Display device 104 may be operatively connected to entertainment system 102 via a display output of the entertainment system. For example, entertainment system 102 may include an HDMI or other suitable wired or wireless display output. Display device 104 may receive video content from entertainment system 102, and/or it may include a separate receiver configured to receive video content directly from a content provider.

The capture device 106 may be operatively connected to the entertainment system 102 via one or more interfaces. As a non-limiting example, the entertainment system 102 may include a universal serial bus to which the capture device 106 may be connected. Capture device 106 may be used to recognize, analyze, and/or track one or more human subjects and/or objects within a physical space, such as user 108. In one non-limiting example, capture device 106 may include an infrared light to project infrared light onto the physical space and a depth camera configured to receive infrared light.

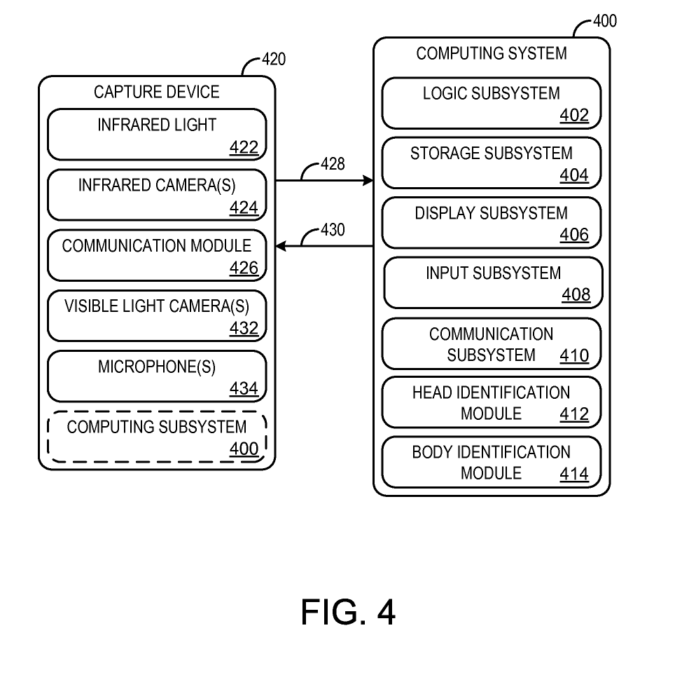

In order to image objects within the physical space, the infrared light may emit infrared light that is reflected off objects in the physical space and received by the depth camera. Based on the received infrared light, a depth map of the physical space may be compiled. Capture device 106 may output the depth map derived from the infrared light to entertainment system 102, where it may be used to create a representation of the play space imaged by the depth camera. The capture device may also be used to recognize objects in the play space, monitor movement of one or more users, perform gesture recognition, etc. For example, whether a user is entering a vote or not by raising his or her hand may be determined based on information received from the capture device. Virtually any depth finding technology may be used without departing from the scope of this disclosure. Example depth finding technologies are discussed in more detail with reference to FIG. 4.

Entertainment system 102 may be configured to communicate with one or more remote computing devices, not shown in FIG. 1. For example, entertainment system 102 may receive video content directly from a broadcaster, third party media delivery service, or other content provider. Entertainment system 102 may also communicate with one or more remote services via the Internet or another network, for example in order to analyze depth information received from capture device 106.

While the embodiment depicted in FIG. 1 shows entertainment system 102, display device 104, and capture device 106 as separate elements, in some embodiments one or more of the elements may be integrated into a common device. For example, entertainment system 102 and capture device 106 may be integrated in a common device.

Entertainment system 102 may utilize image data collected from capture device 106 to determine if one or more of the users 108, 110, 112, and 114 are performing a natural user interface input, such as a vote via an arm-raising gesture made in response to a selectable option presented via display device 104. In the example depicted in FIG. 1, user 110 and user 114 are each entering a vote for a choice presented in video content displayed on display device 104 by raising a hand. The example scenarios described below with respect to FIGS. 1-3 are specific to entering a vote via raising a hand. However, entering a vote by raising a hand is one non-limiting example of natural user interface input that may be used to enter a vote. Other examples of natural user interface input that may be detected by entertainment system 102 and used to enter a vote include raising a leg, tilting a torso, sitting, standing, and other forms of input.

Entertainment system 102 may be configured to detect which users are raising a hand based on the image data received from capture device 106. Further, entertainment system 102 may be configured to detect which hand (e.g., right or left) each user is raising. In order to detect which users are raising a hand to enter a vote, entertainment system 102 may identify one or more bodies present in the imaged scene, and identify one or more heads also present in the imaged scene. Entertainment system 102 may then identify one or more head-body pairs by associating an identified head with an identified body. If a mass is located within a threshold range of a head, entertainment system 102 may identify the mass as a hand. Based on a position of the hand relative to the head, entertainment system 102 may further determine if the user is entering a vote by raising his or her hand.

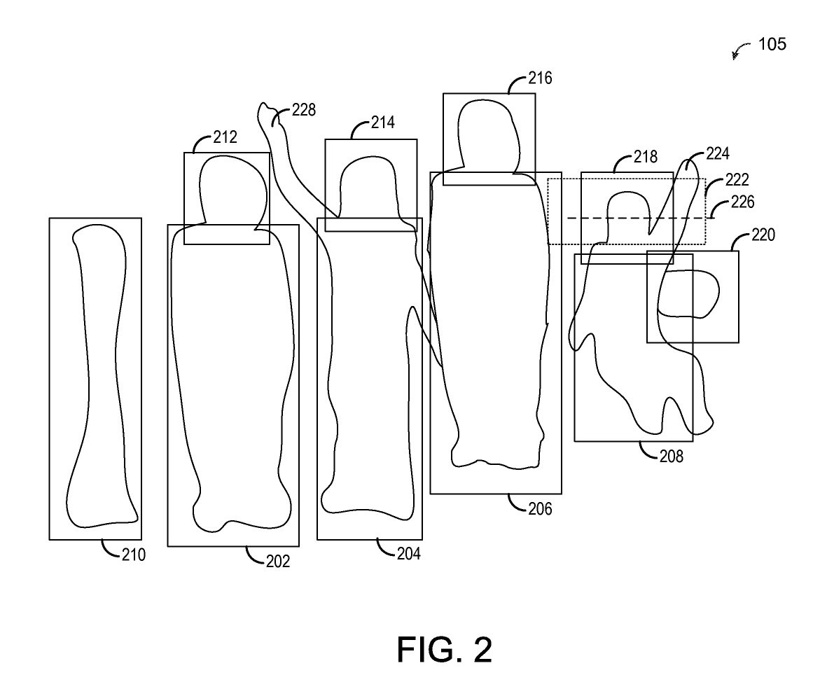

FIG. 2 shows a schematic depiction of blob and head data identified in processed image data. The processed image data shows a low resolution depiction of object edges detected in the image, for example, via a discontinuity in depth image data. The processed image data also represents occlusions of some objects by others. From this low resolution, objects that are potentially bodies, heads, arms and other appendages may be identified. Bodies, heads and other body parts may be identified in any suitable manner. For example, a detected blob may be determined to be a body if the blob is of a certain size and/or shape, such as a size and shape that generally corresponds to a human body. In other embodiments, all blobs detected by entertainment system 102 may be identified as bodies. As shown in FIG. 2, entertainment system 102 has identified body 202, body 204, body 206, body 208, and body 210, as indicated by rectangular outlines around the corresponding blobs.

Additionally, entertainment system 102 may identify one or more heads in play space 105. Similar to body identification, head identification may be based on detection of a blob having a certain size and/or shape. Further, in some embodiments, even if a blob has a size and shape indicative of a head, a head may not be positively identified unless it is associated with at least part of a body (e.g., a body blob immediately below). As shown in FIG. 2, entertainment system 102 has identified head 212, head 214, head 216, head 218, and head 220.

Based on the determined heads and bodies, entertainment system 102 may identify one or more head-body pairs within play space 105. Head-body pairs may be identified based on the position of an identified head relative to an identified body. For example, if a head is positioned proximate to a body such that the head is centered over and overlaps the body, then a head-body pair may be identified. In the example shown in FIG. 2, head 212 is centered over body 202. Further, head 212 overlaps body 202 such that no space is detected between head 212 and body 202. Thus, head 212 and body 202 may be identified as a head-body pair. Similarly, head 214 and body 204 may form a head-body pair, head 216 and body 206 may form a head-body pair, and head 218 and body 208 may form a head-body pair, as each respective head is centered over and overlaps a respective body. Each identified head-body pair may correspond to a user illustrated in FIG. 1.

In some embodiments, entertainment system 102 also may determine the identity of each user in play space 105, and associate a head-body pair with each identified user. In doing so, each vote detected by entertainment system 102 (as explained in more detail below) may be correlated with a specific user. However, in other embodiments, each head-body pair may be assumed to correspond to a user, but may not be associated with a specific user.

Entertainment system 102 may also identify detected head and/or body blobs that are not part of a head-body pair. For example, a head has not been identified that is proximate to body blob 210. Further, head blob 220 is not located over a corresponding body blob, but is instead located proximate to body 208, which is associated with head 218. Therefore, body 210 and head 220 may be determined not to be actual heads and bodies of users, but rather other objects in the room. For example, body blob 210, given its location and shape, may correspond to coat rack 118 of FIG. 1. Further, head blob 220 may correspond to plant 116 of FIG. 1.

Once entertainment system 102 has identified one or more head-body pairs, each head-body pair may be analyzed to determine if that head-body pair includes a hand or arm close to the head of that head-body pair. In order to identify a hand for a given head-body pair, entertainment system 102 may search for a mass or portion of a blob within a window surrounding the head of the head-body pair. If a mass is identified, the position of the mass relative to the head may be evaluated to differentiate the hand from other features of the head-body pair (such as hair or a clothing item) and/or determine if the hand is in a position indicative of entering a vote (e.g., raised).

Any suitable analysis may be used to determine whether a hand is in a position indicative of entering a vote. For example, entertainment system 102 may analyze image information corresponding to a window of play space 105 surrounding head 218. The window may include play space of a certain distance to the right of head 218 and to the left of head 218. As a more specific example, a window 222 comprising the play space corresponding to head 218 as well as play space within a given distance (such as 30 cm) to the left and to the right of head 218 may be analyzed. As shown in FIG. 2, a mass 224 is present within window 222.

Mass 224 may be identified as a hand or arm if mass 224 is in a threshold range of head 218 and/or is connected to body 208. For example, the threshold range may include the mass being spaced apart from head 218 by a first threshold distance, while still within a second threshold distance from head 218 (e.g., the second threshold distance may be an edge of window 222). The first threshold distance between the head and the mass may be a suitable distance that indicates the head and mass do not overlap, and are separate objects. This may differentiate a hand from a feature of a head, such as a large hair-do. Thus, because mass 224 does not completely overlap head 218 (e.g., some space exists between mass 224 and head 218), mass 224 may be identified as a hand 224.

Once a hand has been identified, entertainment system 102 may determine if the hand is raised sufficiently to register a voting input. In order to determine if hand 224 is raised, the midpoint of head 218 may be determined and a centerline of the head estimated, which is depicted in FIG. 2 as centerline 226. The position of hand 224 relative to the midpoint also may be identified. As depicted in

FIG. 2, hand 224 is at least partially above centerline 226, and thus it is determined that hand 224 is being raised. Further, entertainment system 102 may determine if hand 224 is to the left or to the right of head 218. For example, hand 224 may be to the right of head 218. In some embodiments, whether the raised hand is to the left or the right of a head may indicate which choice of two choices a user is registering a vote for. For example, as hand 224 is to the right of head 218, user 114 (corresponding to head 218 and body 208) may be entering a vote for a first choice, while user 110 (corresponding to head 214 and body 204) may be entering a vote for a second choice, as hand 228 is to the left of head 214. Additionally, the position of the raised hand relative to the head and/or body may also be determined. For example, if a hand of a user is raised near the head of that user, the user may be indicating a vote for a first choice, and if the hand is raised substantially above the head, the user may be indicating a vote for a second, different choice. In another example, if the hand is a first, shorter distance from the body, the user may be entering a vote for a first choice, but if the hand is a second, longer distance from the body, the user may be entering a vote for a second, different choice.

While FIG. 2 illustrates identification of head-body pairs and accompanying hands via blob identification, other mechanisms of identifying heads, bodies, and arms of users in a play space are possible. For example, depth information captured from a depth camera (e.g., capture device 106) may be used to identify joints and vertices between the joints in order to model each user as a virtual skeleton. Based on the virtual skeletons, the position of each user's hand may be tracked to determine if each user is entering a vote. Further, it will be understood that the concepts herein may be applied to the identification of any other suitable extremity or extremeties, and to the use of any other suitable comparison(s) of such extremity or extremities to a head and/or body based upon blob identification.

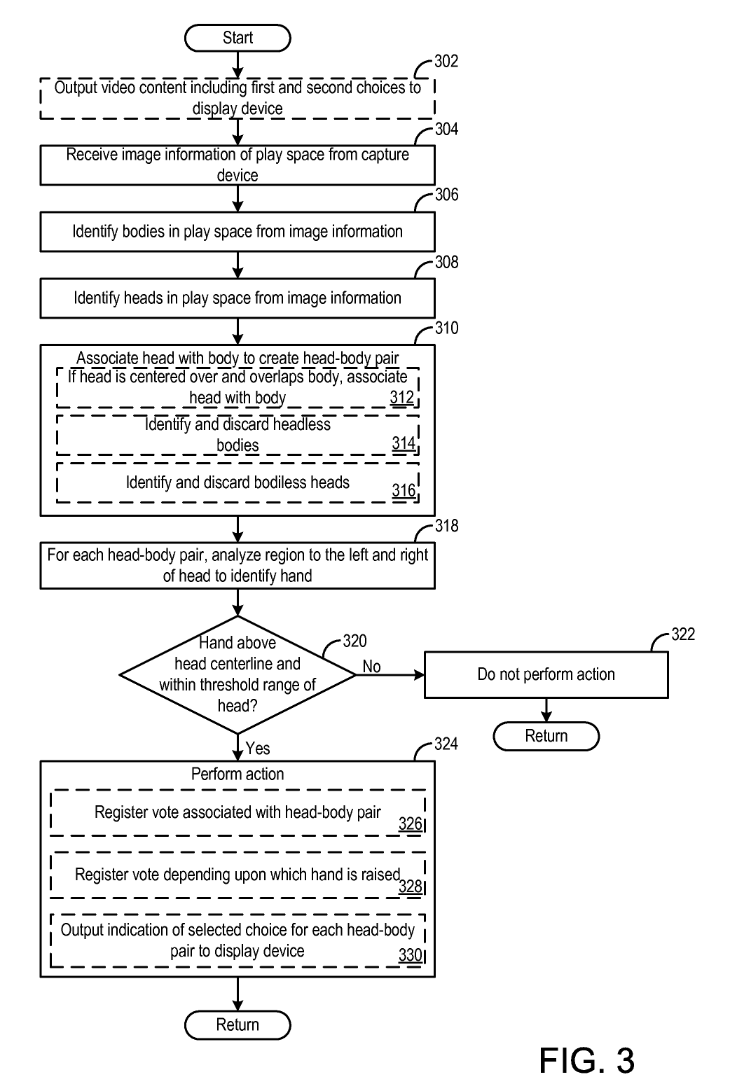

Turning now to FIG. 3, a method 300 for registering a vote is presented. Method 300 may identify one or more head-body pairs in a play space based on received image data, and determine if a hand is being raised by the identified head-body pair. While method 300 is described specifically for detection of a raised hand, the position of other extremities relative to the head and/or body may also be used to determine if the user is registering a vote. For example, the position of a user's leg relative to the user's body may be determined. Method 300 may be carried out by a computing device, such as entertainment system 102, including or coupled to a capture device, such as capture device 106, while video content including selectable choices is presented on a display device, such as display device 104.

At 302, method 300 optionally includes outputting video content including at least first and second choices to a display device. Any suitable video content may be output, including but not limited to a video game, movie, television show, etc. Likewise, the first and second choices may be answers to a question posed in the video content, for example. In some instances, the first and second choices may be output in the video content concurrently, that is, the first and second choices may be presented in the same display device screen. In such examples, the first and second choices may represent two answers to the same question (e.g. yes or no), while in other examples the two choices may represent answers to two separate questions. Further, the first and second choices may both be explicitly stated, or one may be implied as a non-response to an explicitly stated question. In other instances, the first choice may be displayed separately or non-concurrently from the second choice. In other embodiments, the first and second choices may be output as audio content, or in any other suitable form. Further, more than two choices may be output in the video content.

At 304, method 300 includes receiving image information of a play space from a capture device. The image information may include depth image information, RGB image information, and/or other suitable image information. At 306, one or more bodies in the play space are identified from the image information. As explained above with respect to FIG. 2, bodies may be identified based on a size and/or shape of blobs detected in the play space. At 308, one or more heads in the play space are identified from the image information. The heads may also be identified based on the size and/or shape of blobs detected in the play space, or in any other suitable manner.

At 310, an identified head is associated with an identified body to create a head-body pair. As indicated at 312, a head-body pair may be identified if a head is centered over and overlaps a body. Further, as indicated at 314, bodies that are not associated with a head (e.g., headless bodies) may be identified and discarded. Additionally, as indicated at 316, bodiless heads, that is, heads that are not associated with a body, may also be identified and discarded.

For each head-body pair identified, a region extending across the left and the right of the head may be analyzed at 318 to identify a hand. A hand may be identified if a mass is located within the analyzed region, yet some threshold distance from the head. Further, in some embodiments, a hand may be identified if the mass that is located within the analyzed region also is connected to the body of the head-body pair. The mechanism described above for identifying a hand only identifies hands that are at or near head-level, and does not identify hands that are extended downward, at a user's side, or other positions. However, it is to be understood that hands may be present that are not identified by the above-described mechanism, and that hands may be identified using any other suitable technique.

To determine if the identified hand is being raised by a user, method 300 may comprise determining if the hand meets a predetermined condition relative to the head. In some embodiments, the predetermined condition may include at least a portion of the hand being equal to or above a centerline of the head. Further, the predetermined condition may also include, in some embodiments, the hand being within a threshold range of the head. The identified hand may be above the centerline if at least a portion of the hand is level with or above the estimated centerline of the head. Further, the hand being within the threshold range of the head may include the hand being spaced apart from an edge of the head by at least a first threshold distance but not exceeding a second threshold distance from the edge of the head.

If it is determined that the answer at 320 is no, and that the hand is not above the centerline of the head and within a threshold range of the head, method 300 comprises, at 322, not performing an action. However, if it is determined that the answer at 320 is yes, and that the hand is above the centerline and within a threshold range of the head, then method 300 comprises, at 324, performing an action.

Any suitable action may be performed in response to detecting the hand within the threshold conditions relative to the head. In one example, the action may include registering a vote that is associated with the head-body pair, as indicated at 326. As mentioned above, such vote may be a vote for one of two or more choices, such as first and second choices presented in video content output to the display device at 302. For example, a vote may be registered to select a direction to send a character in a game, select a media type to view or branch within displayed video content, select a designated user from a group of users, etc. In some embodiments, the side of the head that the hand is on may be determined to determine what choice the user is selecting, as indicated at 328. In other embodiments, a raised hand may indicate a vote for one choice while a lack of a raised hand may indicate a vote for another choice.

Additionally, as indicated at 330, an indication of each selected choice voted by each head-body pair may be output to the display device, or otherwise presented. The indication may be output in a suitable form. For example, in some embodiments, each head-body pair may be represented in the video content output to the display device, and the vote entered by each head-body pair may be indicated on the display device in association with the corresponding head-body pair. In another example, a tally of all the votes entered by all the head-body pairs may be output to the display device, or otherwise presented.

While the method of FIG. 3 is described for identifying one head-body pair and determining if the user associated with that head-body pair is entering a vote, identification of more than one head-body pair is possible. Virtually any number of users present in the play space imaged by the capture device may be identified, and for each identified head-body pair, it may be determined if a vote is being entered. Further, users present in more than one physical space may also be identified. For example, multiple capture devices may be present in multiple physical spaces, and the image information from each capture device may be used to identify is users are entering a vote. Additionally, rather than identifying head-body pairs and associated hands, an entire skeleton of each user may be modeled. In order to determine if a user is entering a vote, the virtual skeleton of that user may be tracked and if a hand of that virtual skeleton is moved to a voting position (e.g., to the side or above a head of the virtual skeleton), then a vote may be entered.

In some embodiments, the methods and processes described above may be tied to a computing system of one or more computing devices. In particular, such methods and processes may be implemented as a computer-application program or service, an application-programming interface (API), a library, and/or other computer-program product.

FIG. 4 schematically shows a non-limiting embodiment of a computing system 400 that can enact one or more of the methods and processes described above. Computing system 400 is shown in simplified form. It will be understood that any suitable computer architecture may be used without departing from the scope of this disclosure. In different embodiments, computing system 400 may take the form of a mainframe computer, server computer, desktop computer, laptop computer, tablet computer, home-entertainment computer, network computing device, gaming device, mobile computing device, mobile communication device (e.g., smart phone), wearable computing device, etc.

Computing system 400 includes a logic subsystem 402 and a storage subsystem 404. Computing system 400 may optionally include a display subsystem 406, input subsystem 408, communication subsystem 410, and/or other components not shown in FIG. 4.

Logic subsystem 402 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Storage subsystem 404 includes one or more physical devices configured to hold machine-readable data and/or instructions executable by the logic subsystem to implement the methods and processes described herein. When such methods and processes are implemented, the state of storage subsystem 404 may be transformed—e.g., to hold different data.

Storage subsystem 404 may include removable media and/or built-in devices. Storage subsystem 404 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 404 may include volatile, nonvolatile, dynamic, static, read/write, read-only, random-access, sequential-access, location-addressable, file-addressable, and/or content-addressable devices.

It will be appreciated that storage subsystem 404 includes one or more physical data storage devices and/or media. However, in some embodiments, aspects of the instructions described herein may be propagated in a transitory fashion by a pure signal (e.g., an electromagnetic signal, an optical signal, etc.) via a communications media, as opposed to a physical storage device and/or media. Furthermore, data and/or other forms of information pertaining to the present disclosure may be propagated by a pure signal.

In some embodiments, aspects of logic subsystem 402 and of storage subsystem 404 may be integrated together into one or more hardware-logic components through which the functionally described herein may be enacted. Such hardware-logic components may include field-programmable gate arrays (FPGAs), program- and application-specific integrated circuits (PASIC / ASICs), program- and application-specific standard products (PSSP / ASSPs), system-on-a-chip (SOC) systems, and complex programmable logic devices (CPLDs), for example.

The term “module” may be used to describe an aspect of computing system 400 implemented to perform a particular function. In some cases, a module, may be instantiated via logic subsystem 402 executing instructions held by storage subsystem 404. It will be understood that different modules may be instantiated from the same application, service, code block, object, library, routine, API, function, etc. Likewise, the same module may be instantiated by different applications, services, code blocks, objects, routines, APIs, functions, etc. The term “module” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 406 may be used to present a visual representation of data held by storage subsystem 404. This visual representation may take the form of a graphical user interface (GUI). As the herein described methods and processes change the data held by the storage subsystem, and thus transform the state of the storage subsystem, the state of display subsystem 406 may likewise be transformed to visually represent changes in the underlying data. Display subsystem 406 may include one or more display devices utilizing virtually any type of technology. Such display devices may be combined with logic subsystem 402 and/or storage subsystem 404 in a shared enclosure, or such display devices may be peripheral display devices.

When included, input subsystem 408 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone or microphone array for speech and/or voice recognition; an infrared, color, steroscopic, and/or depth camera for machine vision and/or gesture recognition; and/or a head tracker, eye tracker, accelerometer, and/or gyroscope for motion detection and/or intent recognition.

When included, communication subsystem 410 may be configured to communicatively couple computing system 400 with one or more other computing devices. Communication subsystem 410 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

Further, computing system 400 may include a head identification module 412 configured to receive imaging information from a capture device 420 (described below) and identify one or more heads from the imaging information. Computing system 400 may also include a body identification module 414 to identify one or more bodies from the received imaging information. Both head identification module 412 and body identification module 414 may identify blobs within the imaged scene, and determine if the blob is either a head or body based on characteristics of the blob, such as size and shape. While head identification module 412 and body identification module 414 are depicted as being integrated within computing system 400, in some embodiments, one or both of the modules may instead be included in the capture device 420. Further, the head and/or body identification may instead be performed by a network-accessible remote service.

Computing system 400 may be operatively coupled to the capture device 420. Capture device 420 may include an infrared light 422 and one or more depth cameras 424 (also referred to as an infrared light camera) configured to acquire video of a scene including one or more human subjects. The video may comprise a time-resolved sequence of images of spatial resolution and frame rate suitable for the purposes set forth herein. As described above with reference to FIGS. 1 and 2, the depth camera and/or a cooperating computing system (e.g., computing system 400) may be configured to process the acquired video to identify one or more head-body pairs, determine a location of a hand associated with the head-body pair, and if the hand is above a midpoint of a head, to interpret the position of the hand as a device command configured to control various aspects of computing system 500.

Capture device 420 may include a communication module 426 configured to communicatively couple capture device 420 with one or more other computing devices. Communication module 426 may include wired and/or wireless communication devices compatible with one or more different communication protocols. In one embodiment, the communication module 426 may include an imaging interface 428 to send imaging information (such as the acquired video) to computing system 400. Additionally or alternatively, the communication module 426 may include a control interface 430 to receive instructions from computing system 400. The control and imaging interfaces may be provided as separate interfaces, or they may be the same interface. In one example, control interface 430 and imaging interface 428 may include a universal serial bus.

The nature and number of cameras may differ in various depth cameras consistent with the scope of this disclosure. In general, one or more cameras may be configured to provide video from which a time-resolved sequence of three-dimensional depth maps is obtained via downstream processing. As used herein, the term ‘depth map’ refers to an array of pixels registered to corresponding regions of an imaged scene, with a depth value of each pixel indicating the depth of the surface imaged by that pixel. ‘Depth’ is defined as a coordinate parallel to the optical axis of the depth camera, which increases with increasing distance from the depth camera.

In some embodiments, capture device 420 may include right and left stereoscopic cameras. Time-resolved images from both cameras may be registered to each other and combined to yield depth-resolved video.

In some embodiments, a “structured light” depth camera may be configured to project a structured infrared illumination comprising numerous, discrete features (e.g., lines or dots). A camera may be configured to image the structured illumination reflected from the scene. Based on the spacings between adjacent features in the various regions of the imaged scene, a depth map of the scene may be constructed.

In some embodiments, a “time-of-flight” depth camera may include a light source configured to project a pulsed infrared illumination onto a scene. Two cameras may be configured to detect the pulsed illumination reflected from the scene. The cameras may include an electronic shutter synchronized to the pulsed illumination, but the integration times for the cameras may differ, such that a pixel-resolved time-of-flight of the pulsed illumination, from the light source to the scene and then to the cameras, is discernible from the relative amounts of light received in corresponding pixels of the two cameras.

Capture device 420 also may include one or more visible light cameras 432 (e.g., color or RGB). Time-resolved images from color and depth cameras may be registered to each other and combined to yield depth-resolved color video. Capture device 420 and/or computing system 400 may further include one or more microphones 434.

While capture device 420 and computing system 400 are depicted in FIG. 4 as being separate devices, in some embodiments capture device 420 and computing system 400 may be included in a single device. Thus, capture device 420 may optionally include computing system 400.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for operating a computing device, comprising:
receiving image information of the play space from a capture device;
identifying a body of a user within the play space from the received image information;
identifying a head within the play space from the received image information;
associating the head with the body of the user;
identifying an extremity; and
if the extremity meets a predetermined condition relative to one or more of the head and the body of the user, then performing an action.

2. The method of claim 1, wherein the extremity includes a hand.

3. The method of claim 2, wherein identifying the hand further comprises analyzing image information of the play space within a window extending across a left side and a right side of the head, and if a mass is detected within the window, identifying the hand.

4. The method of claim 2, further comprising determining a centerline through the head, and wherein the predetermined condition relative to one or more of the head and the body comprises the hand being equal to or above the centerline and within a threshold distance of the head.

5. The method of claim 1, wherein performing the action comprises registering that the user is entering a vote for a choice presented on a display device.

6. The method of claim 1, further comprising, if the extremity does not meet the predetermined condition relative to one or more of the head and the body, then not performing the action.

7. The method of claim 1, wherein associating the head with the body further comprises determining a position of the head relative to the body, and if the head is centered over and overlapping with the body, then associating the head with the body.

8. A storage subsystem holding instructions executable by a logic subsystem to:
receive image information of a play space from a capture device;
identify a plurality of bodies within the play space from the received image information;
identify a plurality of heads within the play space from the received image information;
identify at least one head-body pair from among the plurality of heads and the plurality of bodies; and
for each head-body pair,
identify an extremity of that head-body pair; and
if the extremity of that head-body pair meets a predetermined condition relative to one or more of the head and body of that head-body pair, then perform an action.

9. The storage subsystem of claim 10, wherein the instructions are executable to determine if a head of the plurality of heads is centered over and overlapping a body of the plurality of bodies, and if so, associate that head with that body to identify a head-body pair.

10. The storage subsystem of claim 8, wherein the instructions are executable to analyze the image information within a window extending across a left side and a right side of the head, and if a mass is detected within the window, then identify a hand.

11. The storage subsystem of claim 8, wherein the instructions are further executable to, for each head-body pair, determine a centerline through the head of that head-body pair.

12. The storage subsystem of claim 11, wherein the extremity comprises a hand, and wherein the predetermined condition relative to one or more of the head and body comprises the hand being equal to or above the centerline and within a threshold distance of the head.

13. The storage subsystem of claim 8, wherein the action comprises registering that that head-body pair is entering a vote for a choice presented on a display device.

14. The method of claim 8, wherein the instructions are further executable to, if the extremity does not meet the predetermined condition relative to one or more of the head and body, not perform the action.

15. On a computing device, a method for registering votes, comprising:
outputting to a display device video content including a first selectable choice and a second selectable choice;
receiving image information of a play space from a capture device;
identifying one or more head-body pairs from the received image information;
for each head-body pair,
identifying if a hand of that head-body pair is within a threshold distance from a head of that head-body pair from the received image information; and
if the hand of that head-body pair meets a predetermined condition relative to the head of that head-body pair, then registering a vote for either the first selectable choice or the second selectable choice.

16. The method of claim 15, wherein outputting to the display device video content including the first selectable choice and the second selectable choice further comprises outputting to the display device video content including the first selectable choice non-concurrently with video content including the second selectable choice.

17. The method of claim 15, wherein identifying the one or more head-body pairs comprises:
identifying one or more bodies within the play space from the received image information;
identifying one or more of heads within the play space from the received image information; and
if a head of the one or more heads is centered over and overlapping a body of the one or more of bodies, associating that head with that body to identify a head-body pair.

18. The method of claim 15, wherein registering a vote for either the first selectable choice or second selectable choice further comprises:
if the hand of that head-body pair is above a centerline and on a right hand side of the head of that head-body pair, then registering the vote for the first selectable choice; and
if the hand of that head-body pair is above the centerline and on a left hand side of the head of that head-body pair, then registering the vote for the second selectable choice.

19. The method of claim 15, further comprising outputting an indication of the registered vote for each head-body pair to the display device.

20. The method of claim 15, further comprising modeling a virtual skeleton of each user present in the play space based on the received image information in order to identify the one or more head-body pairs and associated hands.
